(19) United States
(12) Patent Application Publication
(10) Pub. No.: US 2010/0215794 A1
(43) Pub. Date: Aug. 26, 2010

(54) Diffusion film molding tool & manufacturing process thereof

(75) Inventors: Chien-Cheng Lin, Taoyuan County (TW); Shan-Er Hsieh, Taoyuan County (TW); Cheng Lin, Taoyuan County (TW)

Correspondence Address: Jackson Intellectual Property Group PLLC, 106 Starvale Lane, Shipman, VA, 22971, US

(73) Assignee: ENTIRE TECHNOLOGY CO., LTD.

(21) Appl. No.: 11/896,933

(22) Filed: Sep. 6, 2007

(51) Int. Cl. B28B 5/00; B28B 7/38

(52) U.S. Cl. 425/470; 427/133

(57) ABSTRACT

A diffusion film molding tool and a manufacturing process thereof includes a locating member disposed on one side of a base plate; multiple micro-particles are arranged and secured on the base plate using the locating member; one side of the base plate disposed with those micro-particles are given processes of deposition and plating to form the diffusion film molding tool; the finished diffusion film molding tool includes a substrate; multiple indents are disposed on one surface of the substrate; and multiple microstructures corresponding to each and all those indents are molded on the diffusion film when the diffusion film molding tool is applied in the production of the diffusion film.

### BACKGROUND OF THE INVENTION

(a) Field of the Invention

The present invention is related to a molding tool and a process for manufacturing a diffusion film molding tool, and more particularly to a molding tool and a manufacturing process of the diffusion film molding tool that can be applied in a backlight unit.

(b) Description of the Prior Art

TFT-LCD so far a commodity that is more comprehensively as a display is essentially comprised of two members, respectively a display panel and a backlight unit to provide light source for the display panel. Depending on the location the light source is disposed the backlight unit is available in side edge emitting type and direct type. The side edge emitting type of the backlight unit is usually applied in a display of smaller size with an LED or a cold cathode fluorescent lamp (CCFL) adapted while the direct type of the backlight unit is usually applied in a display of larger size, e.g., a TV set.

In a direct type backlight unit 1 as illustrated in FIG. 1 of the accompanying drawings, it is comprised of a casing 11 having its inner side coated with a reflective coating that reflects light or attached with a layer of reflective film 12 to reflect a light source; multiple light sources 13 are arranged in sequence at a given gap and a diffuser 14 is disposed over those light sources 13; one or a plurality of optical diffusion film 15 and one or a plurality of brightness enhancement film 16 before being combined with a display panel 17 to form a TFT-LCD.

As illustrated, those light sources 13 in the casing 11 when connected through will immediately emit light. Certain portion of the light directly enters into the diffuser 14 while the remaining light is reflected by the reflective film 12 to other positions in the casing 11 before re-entering into the diffuser 14. The light entering into the diffuser 14 is diffused before entering into the optical diffusion film 15 for further uniform diffusion of the light source while the BEF 16 executes light collection and gathering; and finally, sufficient and uniform light is supplied to the display panel 17 for use in displaying.

Those diffusion optical structures including the diffuser and the optical diffusion film are usually made of acrylic, polycarbonate (PC) or acrylic and styrene copolymer (MS) in sheet and are each given a certain optical permeability. To attain uniform and diffusion effects of the light source, pigment is added in the manufacturing process to make the diffusion optical structure indicating a color of milky white to facilitate diffusion and uniformity of light source. Multiple micro diffusion particles 140 are added as illustrated in FIG. 2 to help light diffusion.

As illustrated in FIG. 3, each diffusion micro-particle 140 is added into a colloidal material 141 and the colloidal material 141 is then coated on a surface of a substrate 18 for the diffusion micro-particle 140 to secure on the surface of the substrate 18 by means of the colloidal material 141 to become a structure of the diffusion film while each diffusion micro-particle 140 forms the diffusion optical structure. However, the method of coating each diffusion micro-particle 140 on the surface of the substrate 18 provides poor pavement results due to its failure to control arrangement of the diffusion micro-particle 140; consequently, the diffusion optical structure of the diffusion film fails to provide better light diffusion and uniform diffusion.

### SUMMARY OF THE INVENTION

The primary purpose of the present invention is to provide a molding tool and a process for manufacturing a diffusion film molding tool by providing a locating member on one side of a base plate; multiple micro-particles are arranged and secured on the base plate by means of the locating member; and the side of the base plate provided with those micro-particles are put through processes in sequence of deposition and plating to form a diffusion film molding tool. The finished diffusion film molding tool is essentially comprised of a substrate with a surface disposed of multiple indents so that when the diffusion molding tool is applied in the production of the diffusion film, multiple microstructures are form on the diffusion film that correspond to each of those indents.

Arrangement and density of those micro-particles may be arranged may vary depending on the arrangement and density of those locating members; and arrangement and density of the indents are adjusted for the diffusion optical structure formed by using the diffusion film molding tool to achieve better light diffusion and uniform diffusion results in a shorter time of the manufacturing process while providing a diffusion film with better arrangement of microstructures.

### BRIEF DESCRIPTION OF THE DRAWINGS

FIG. 1 is a schematic view showing a structure of a direct type of backlight unit generally available in the market.

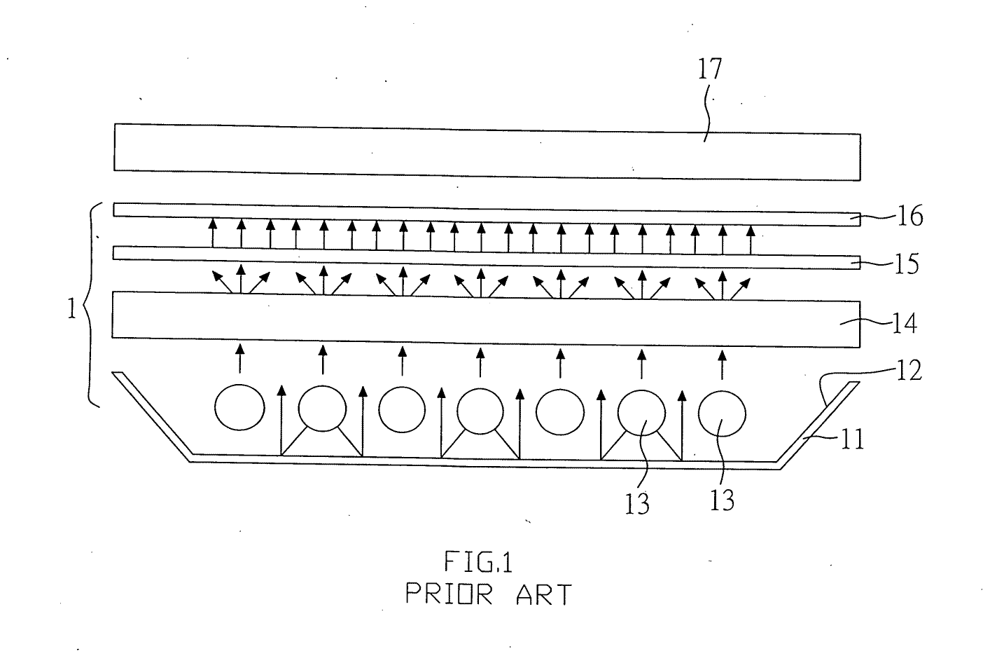

FIG. 2 is a schematic view showing light diffusion from a diffuser of the prior art.

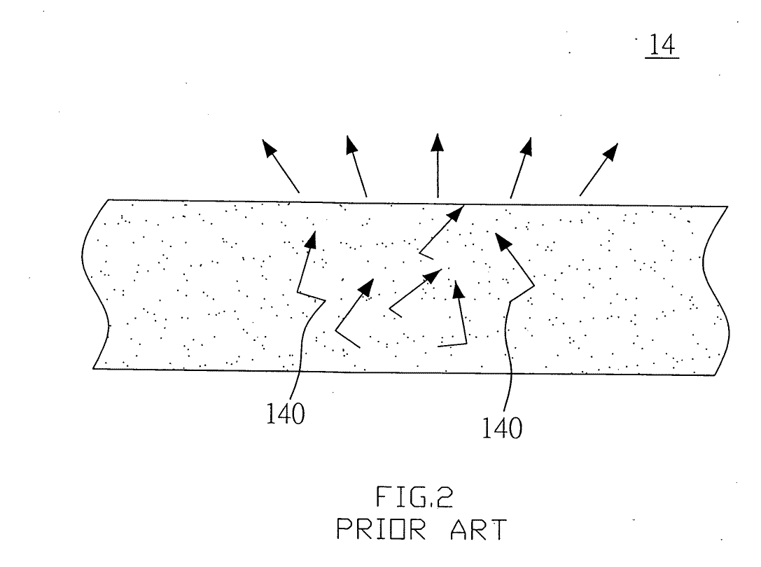

FIG. 3 is a schematic view showing a structure of multiple diffusion micro-particles of the prior art arranged on a substrate.

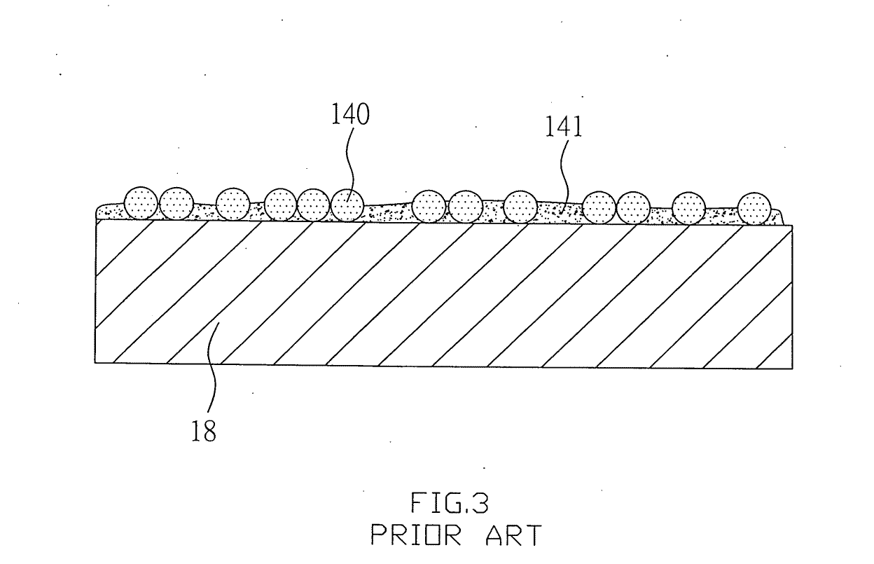

FIG. 4 is a schematic view showing molding process of a diffusion film molding tool of the present invention.

FIG. 5 is a schematic view showing a molding structure of the diffusion film molding tool of the present invention.

FIG. 6 is a schematic view showing a structure of the diffusion film molding tool of the present invention.

FIG. 7 is a schematic view showing a structure of producing the diffusion film with the diffusion film molding tool of the present invention.

FIG. 8 is a schematic view showing another molding structure of the diffusion film molding tool of the present invention.

FIG. 9 is a schematic view showing a structure of multiple micro-particles of the present invention arranged on a base plate.

FIG. 10 is a schematic view showing another structure of the diffusion film molding tool of the present invention.

### DETAILED DESCRIPTION OF THE PREFERRED EMBODIMENTS

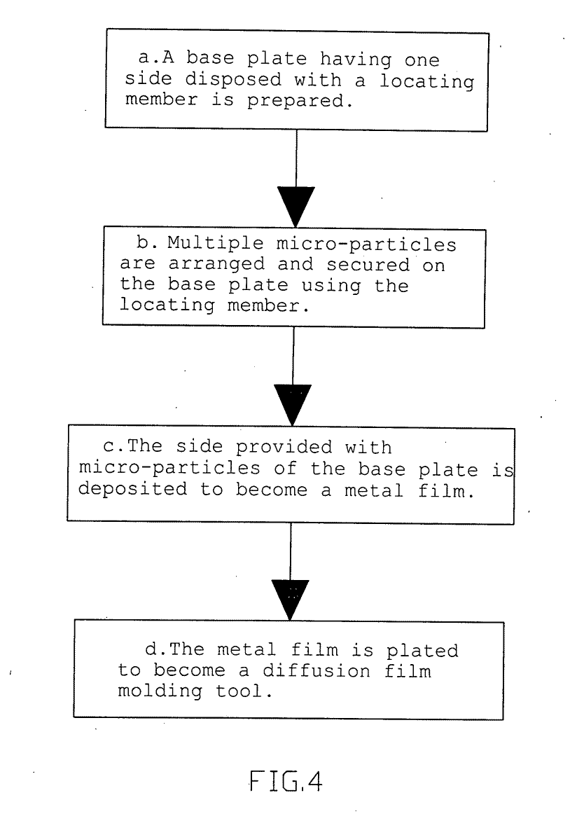

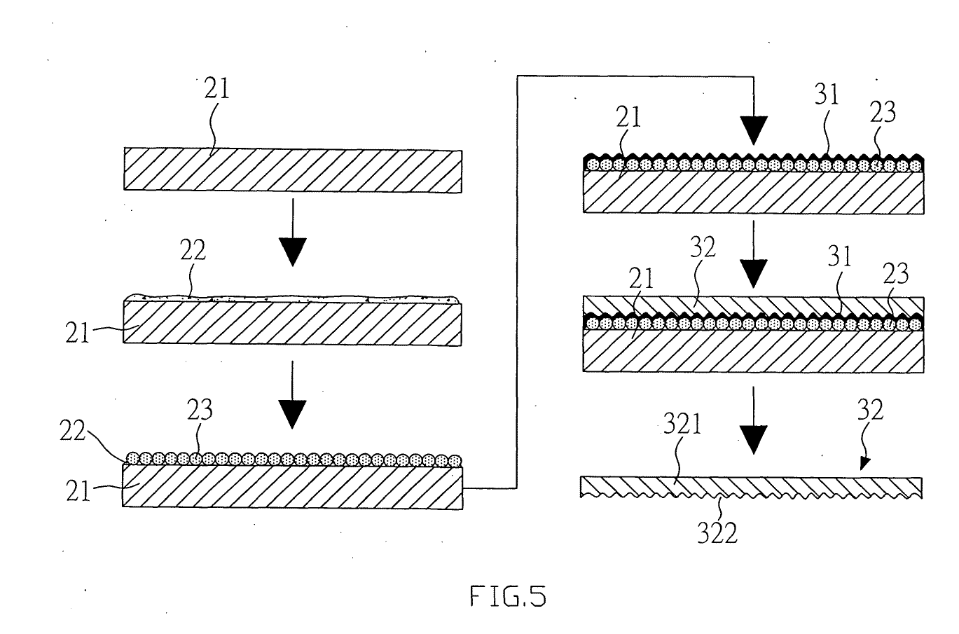

Referring to FIGS. 4 and 5, a process for manufacturing of a diffusion film molding tool of the present invention is comprised of the following steps:

a. Prepare a flat base plate 21 having one side disposed with a locating member 22 by adhesion or by coating.

b. Multiple micro-particles 23 are arranged on the base plate 21 using the locating member 22. Those micro-particles 23 may be disposed as to cover up on the locating member 22; as illustrated, each micro-particle 23 is made in a spherical shape and excessive micro-particles 23 are removed by shaking or vibrating so that each micro-particle 23 is secured to the base plate 21 by the locating member 22; of course, the locating member may be coated on the entire surface of the base plate as illustrated or disposed on a selected position so that those micro-particles 23 are respectively secured on their specific positions.

c. Deposition process is performed to execute physical or chemical deposition on the side of the base plate 21 where those micro-particles 23 are disposed to form a layer of metal film 31 on that side of the base plate 21.

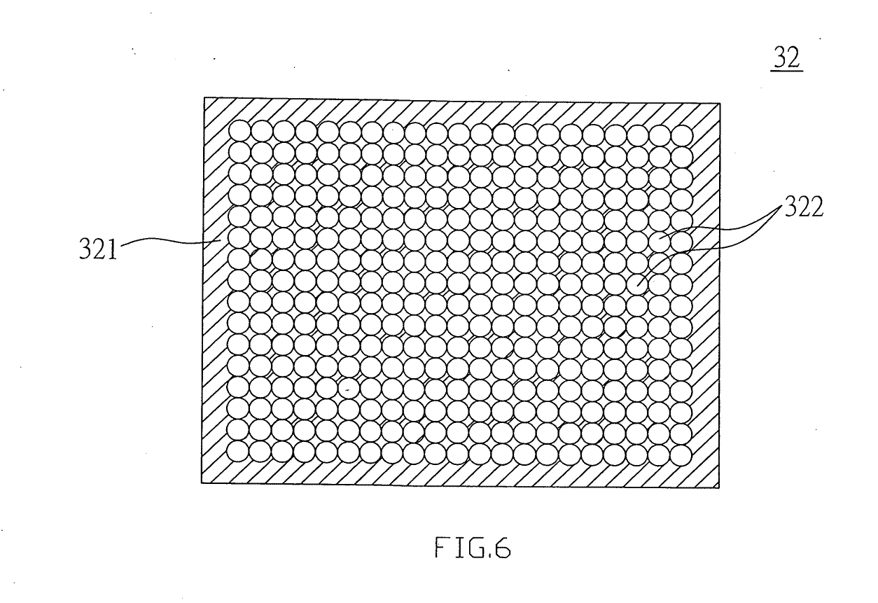

d. Plating process is followed to the metal film layer 31 to give it a certain thickness to become a diffusion film molding tool 32, which is essentially comprised of a substrate 321, and multiple hemispherical indents each corresponding to an individual micro-particle 23 are disposed on a surface of the substrate 321 as illustrated in FIG. 6.

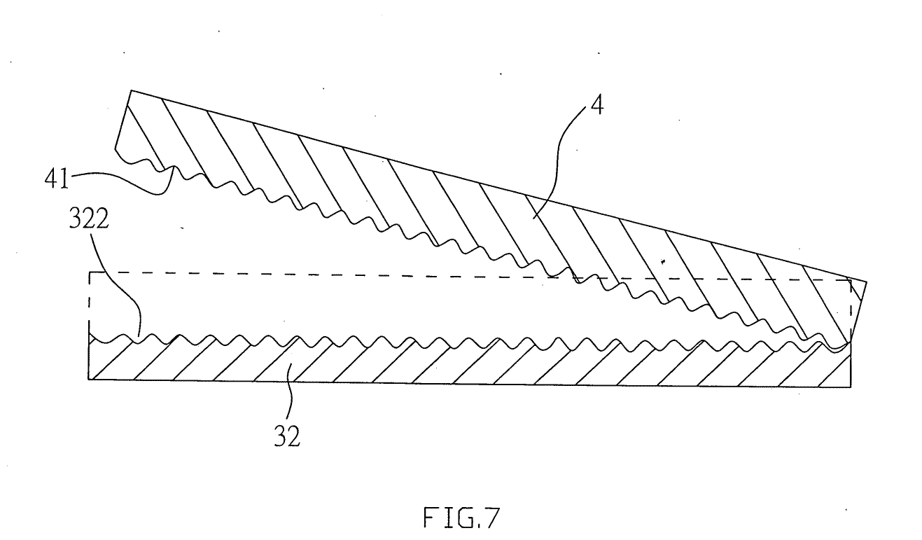

Finally, a diffusion film 4 is molded using the diffusion film molding tool 32 as illustrated in FIG. 7 and multiple microstructures 41 are formed on a surface of the diffusion film 4 corresponding to each and all indents 322. It is to be noted that the present invention by controlling the arrangement and density of the locating member disposed on the prefabricated diffusion film molding tool to determine arrangement and density of multiple micro-particles, thus to adjust those indents to form different arrangement and density; consequently, the diffusion optical structure molded using the diffusion film molding tool delivers better light diffusion and uniform diffusion results; meanwhile, the process time is reduced and a diffusion film with better arrangement of microstructures is provided.

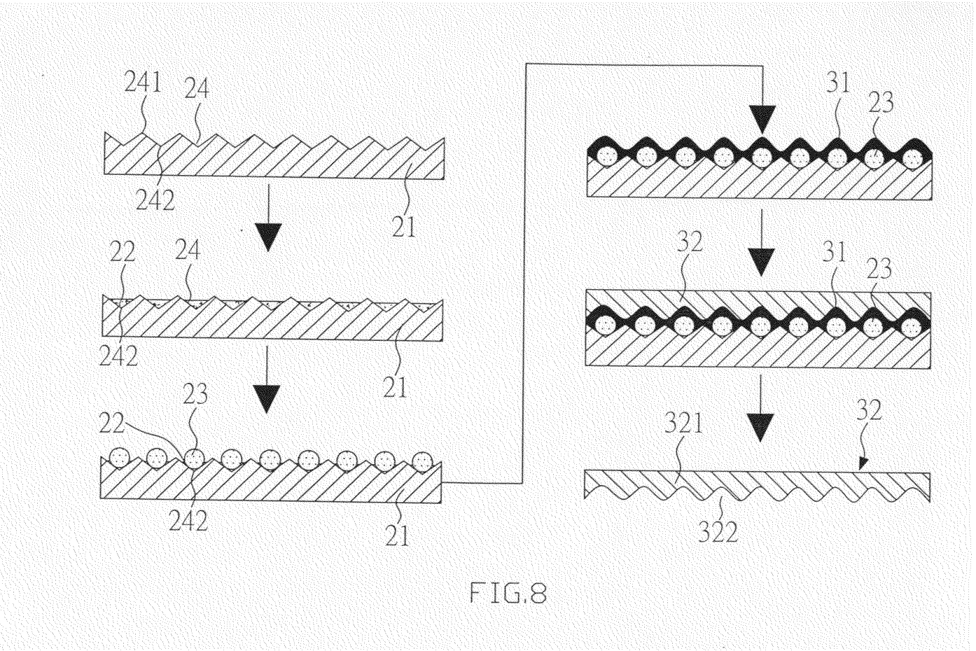

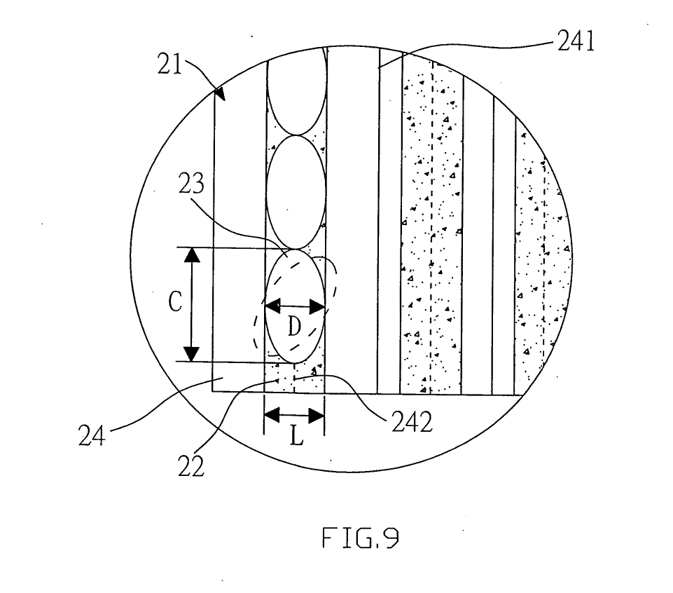

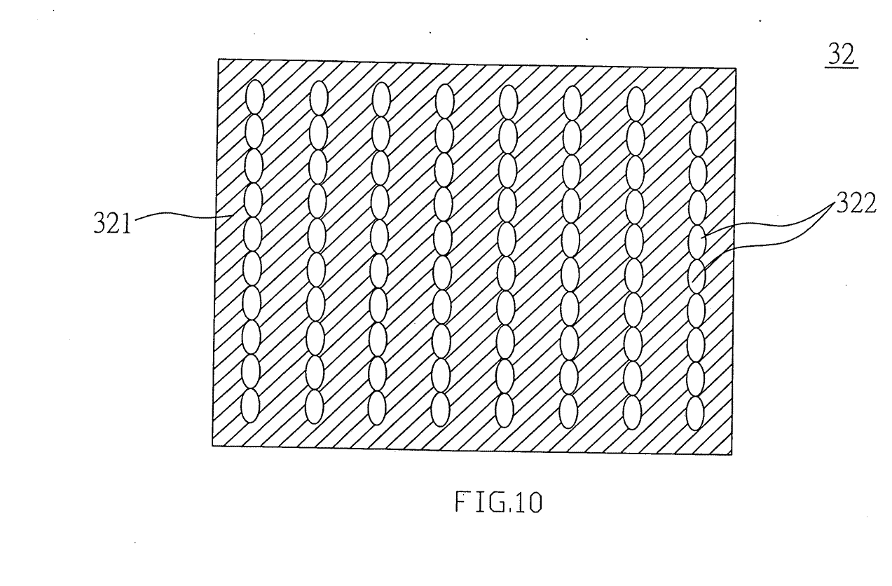

Furthermore, multiple grooves 24 are disposed on one side of the base plate as illustrated in FIG. 8 with each groove comprised of a wave peak 241 and a wave trough 242; the wave trough 242 is disposed with the locating member 22 and the locating member 22 is filled in the wave trough 242 for a maximal width L; and multiple micro-particles 23 are arranged on the base plate 21 using the locating member 22. As illustrated in FIG. 9, each micro-particle is made in an oval shape provided with a longer axis C and a short axis D. The longer axis C is greater than the maximal width L while the shorter axis is not greater than the maximal width L. Therefore, when those micro-particles are arranged on the base plate 21, they are disposed in an extending direction with its longer axis C in parallel with the groove 24. Once all the micro-particles 23 are arranged and secured on the base plate 21, a deposition process and a plating process are performed in sequence to form a layer of the metal film 31 given with a certain thickness to similarly form the diffusion film molding tool 32. Multiple indents 322 are form on the surface of the diffusion film molding tool 32 corresponding to each of all micro-particles 23 and each indent indicates a oval and hemispherical shape as illustrated in FIG. 10. The diffusion film is molded by using the diffusion film molding tool and oval hemispherical microstructures corresponding to each and all indents are formed on the surface of the diffusion film.

The prevent invention provides a molding tool for manufacturing a diffusion film, and the application for a patent is duly filed accordingly. However, it is to be noted that the preferred embodiments disclosed in the specification and the accompanying drawings are not limiting, the present invention; and that any substitution and decoration made by those who are familiar with the art of the present invention without departing from what is taught in the present invention shall be fall within the scope of the purposes and claims of the present invention.

I claim:

1. A diffusion film molding tool comprising a substrate, one surface of the substrate being disposed with multiple indents.

2. The diffusion film molding tool as claimed in claim 1, wherein the indent is made in a hemispherical or oval hemispherical shape.

3. The diffusion film molding tool as claimed in claim 1, wherein a diffusion film structure is molded using the diffusion film molding tool, and multiple microstructures are disposed on a surface of the diffusion film that correspond to each and all indents.

4. A diffusion film molding tool manufacturing process comprising the following steps:
a. A base plate is prepared with one side of the base plate disposed with a locating member;
b. Multiple micro-particles are arranged and secured on the base plate by means of the locating member;
c. A deposition process is performed on the side of the base plate where multiple micro-particles are disposed to form a metal film on that side of the base plate; and
d. A plating process is followed on the metal film to give it a certain thickness for forming a diffusion film molding tool.

5. The diffusion film molding tool manufacturing process as claimed in claim 4, wherein the diffusion film molding tool is essentially comprised of a substrate; and multiple indents are disposed on a surface of the substrate to correspond to each and all the indents.

6. The diffusion film molding tool manufacturing process as claimed in claim 5, wherein the indent is made in a hemispherical or oval hemispherical shape and disposed on the surface of the substrate.

7. The diffusion film molding tool manufacturing process as claimed in claim 4, wherein the locating member relates to an adhesive.

8. The diffusion film molding tool manufacturing process as claimed in claim 4, wherein each micro-particle is made in a spherical shape.

9. The diffusion film molding tool manufacturing process as claimed in claim 4, wherein the base plate is related to a flat plate.

10. The diffusion film molding tool manufacturing process as claimed in claim 4, wherein multiple grooves are disposed on one side of the base plate; each groove is comprised of a wave peak and a wave trough; and a locating member is disposed in each wave trough.

11. The diffusion film molding tool manufacturing process as claimed in claim 10, wherein the micro-particle is made in an oval shape provided with a longer axis and a shorter axis with the longer axis in parallel with a direction extending from the groove.

12. The diffusion film molding tool manufacturing process as claimed in claim 11, wherein the locating member filled in the wave trough for a maximal width; the longer axis of the micro-particle is greater than the maximal width; and the shorter axis of the micro-particle is not greater than the maximal width.

13. The diffusion film molding tool manufacturing process as claimed in claim 4, wherein the deposition process related to a physical or a chemical deposition process.
